(19) United States
(12) Patent Application Publication
(10) Pub. No.: US 2019/0358756 A1
(43) Pub. Date: Nov. 28, 2019

(54) Guide Baffle Of A Turbomachine And Method For Producing The Same

(71) Applicant: MAN Energy Solutions SE, Augsburg (DE)

(72) Inventor: Claudius WURM, Augsburg (DE)

(21) Appl. No.: 16/421,913

(22) Filed: May 24, 2019

(30) Foreign Application Priority Data
May 25, 2018 (DE) 102018112562.3

(51) Int. Cl. B23P 15/04; F01D 9/02

(52) U.S. Cl. CPC B23P 15/04; B33Y 10/00; F01D 9/02

(57) ABSTRACT

A guide baffle of a turbomachine, including a cast or turned main body and guide blades applied to the main body via a generative manufacturing method.

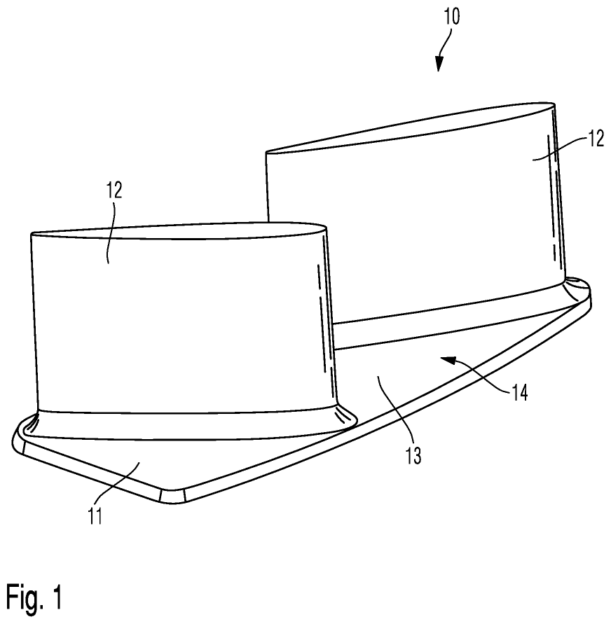

### BACKGROUND OF THE INVENTION

### 1. Field of the Invention

The invention relates to a guide baffle of a turbomachine and to a method for producing the same.

### 2. Description of the Related Art

A turbomachine, such as for example a compressor or a turbine, comprises a rotor and a stator. The rotor of a turbomachine is bladed with multiple moving blades. The stator of a turbomachine includes a housing and typically a guide baffle having multiple guide blades.

According to practice, guide baffles of turbomachines are milled from solid material or are entirely cast. Such guide baffles have both geometrical and also functional limitations.

### SUMMARY OF THE INVENTION

There is a need for a new type of guide baffle of a turbomachine which can be both designed more freely and also provided with further functions.

Starting out from this, one aspect of the present invention is based on creating a new type of guide baffle of a turbomachine and a method for producing the same.

The guide baffle according to the invention comprises a cast or turned main body and guide blades applied to the main body by a generative manufacturing method.

Such a guide baffle in hybrid design or mixed design with a cast or turned main body and with guide blades constructed by way of a generative or additive manufacturing method can provide a new type of blade geometry of the guide blades. Furthermore, further functions for example sound absorption, for the heat shield or the like can be provided.

The main body can be a separate main body especially for the guide baffle. The main body can also be provided by another component of the turbocharger that is present anyway, for example by an insert piece or a heat shield of the turbocharger.

According to an advantageous further development, the guide blades consist of a nickel-base alloy, a titanium-base alloy, or a cobalt-base alloy. Preferentially, the guide blades consist of a nickel-chromium-iron alloy with niobium and molybdenum as well as with aluminum and titanium. These materials are preferred both from the point of view of manufacturing and also of functioning.

The method comprises at least the following steps: providing the cast or turned main body. Roughening of the provided main body, preheating the roughened main body, and building up the guide blades on the roughened and preheated main body via a generative manufacturing method. With such a method, the guide baffle according to the invention can be particularly advantageously manufactured.

As already explained above, the main body can be a separate main body especially for the guide baffle. The main body can also be provided by another component of the turbocharger that is present anyway, for example by an inserted piece or a heat shield of the turbocharger.

According to an advantageous further development, the roughening of the main body is carried out over the full area in such a manner that the main body that is roughened over the full area has a roughness Rz between 25 and 32. The full-area roughening of the main body with a roughness between Rz 25 and Rz 32 is particularly preferred in order to subsequently build up the guide blades via the generative manufacturing method.

According to an advantageous further development, the main body roughened over the full area is preheated over the full area to a temperature between 200° C. and 600° C. The full-area preheating of the roughened main body to a temperature in this temperature range is also particularly preferred for the subsequent building up of the guide blades via the generative manufacturing method.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Preferred further developments of the invention are obtained from the subclaims and the following description. Exemplary embodiments of the invention are explained in more detail by way of the drawing without being restricted to this. There it shows:

The FIGURE is an extract from a guide baffle.

### DETAILED DESCRIPTION OF THE PRESENTLY PREFERRED EMBODIMENTS

The invention relates to a guide baffle of a turbomachine. The invention, furthermore, relates to a method for manufacturing such a guide baffle.

The FIGURE shows an extract form a guide baffle 10 of a turbomachine.

The guide baffle 10 can be a guide baffle of a compressor or a guide baffle of a turbine.

The guide baffle has a main body 11 and multiple guide blades 12.

The main body 11 of the guide baffle 10 according to one aspect of the invention is a cast or turned main body. The main body 11 can be a separate main body especially for the guide baffle 10. The main body 11 can also be provided by another component of the turbocharger that is present anyway, for example by an insert piece or a heat shield of the turbocharger.

The main body 11 is at least in part preferentially an aluminum-silicon-alloy, preferentially of an AlSi alloy of series 4000. Other materials can also be utilized for the main body 11.

The guide blades 12 of the guide baffle 10 are guide blades that are applied to or built up on the main body 11 via a generative manufacturing method, which guide blades are at least in part a nickel alloy or a titanium-base alloy or a cobalt-base alloy.

As nickel-base alloys, Hastelloy X, IN625; IN718; IN939 can be employed for example. As titanium-base alloys, TiAl6V4, TiAl6Nb7 can be employed for example. As cobalt-base alloys, CoCr, MAR-M509 can be employed.

Particularly preferably, the guide blades 12 of the guide baffle 10 consist of a nickel-chromium-iron alloy with constituents of niobium, molybdenum, aluminum, and titanium.

In order to provide such a guide baffle 10, a cast or turned main body 11 is initially provided. As already explained, the main body 11 can be a separate main body specifically for the guide blade. The main body 11 can also be provided by another component of the turbocharger that is present anyway, for example by an insert piece or a heat shield of the turbocharger. Following this, the provided main body 11 is roughened. Following this, the roughened main body is preheated. The guide blades 12 are built up on the roughened and preheated main body by way of a generative manufacturing method.

The roughening of the cast or turned main body is performed over the full area preferentially via shot peening. By way of this, a roughness of Rz 25 to Rz 32 is then provided on the main body 11.

Following the roughening of the main body 11, the same is preheated, namely preferentially over the full area to a temperature between 200° C. and 600° C.

On the main body roughened and preheated in this manner, the guide blades 12 are built up, namely by way of the generative or additive manufacturing method.

Prior to the actual building-up of the guide blades 12 with the help of the generative manufacturing method, the roughened and preheated main body is heated up further with the help of an energy source, preferentially with the help of a laser at least in those places in which the guide blades are to be constructed.

The laser or the energy source is preferentially operated with an output between 400 W and 1000 W to further heat up the relevant regions of the main body before the actual building-up of the guide blades.

The actual building-up of the guide blades 12 with the help of the generative manufacturing method, namely preferentially in that a first layer of a metallic powder of a nickel-chromium-iron alloy is applied to the relevant portions of the main body 11 and subsequently melted with the help of a laser. Following this further heating of the roughened and preheated main body with the help of the energy source, in particular of the laser. This is carried out layer by layer in order to gradually build up the guide blades 12.

Following the roughening and preheating it is also possible to further heat up the main body 11 over the full surface area via the energy source, in particular via the laser and then apply a layer preferentially consisting of the nickel-chromium-iron alloy material on the main body over the full surface area, in order to thus also provide a function layer 14 in those portions 13 of the main body 11 that are formed or positioned between the guide blades 12. Accordingly, in the portions 13 between neighboring guide blades 12 for example a porous structure can be formed which serves for the sound absorption. Furthermore, holes and striae for the flow control can be formed in the portions 13 between neighboring guide blades 12.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed:

1. A guide baffle of a turbomachine, comprising:
a main body that is one of cast or turned; and
guide blades applied to the main body via a generative manufacturing method.

2. The guide baffle according to claim 1, wherein the guide blades comprise at least one of:
a nickel-base alloy,
a titanium-base alloy, and
a cobalt-base alloy.

3. The guide baffle according to claim 2, wherein the main body comprises an aluminum-silicon alloy.

4. The guide baffle according to claim 1, wherein the guide blades comprise a nickel-chromium-iron alloy with niobium, molybdenum, aluminum, and titanium.

5. The guide baffle according to claim 4, wherein the main body is an AlSi alloy of series 4000.

6. A method for producing a guide baffle comprising:
providing a main body that is one of cast and turned;
roughening the provided main body;
preheating the roughened main body;
building guide blades by a generative manufacturing method on the roughened and preheated main body.

7. The method according to claim 6, wherein the roughening of the main body is carried out via shot peening.

8. The method according to claim 6, wherein the roughening of the main body is carried out such that the roughened main body has a roughness Rz between 25 and 32.

9. The method according to claim 6, wherein the main body is roughened over a full surface area.

10. The method according to claim 6, wherein the roughened main body is preheated over a full surface area.

11. The method according to claim 6, wherein the roughened main body is preheated to a temperature between 200° C. and 600° C.

12. The method according to claim 6, wherein prior to the building of the guide blades, the preheated main body is further heated with an energy source.

13. The method according to claim 12, wherein the energy source is a laser at least and the further heating is in respective places of the main body in which the guide blades are built up.

14. The method according to claim 13, wherein the laser is operated with an output between 400 W and 1000 W.

15. The method according to claim 12, further comprising:
further heating the main body following the roughening and preheating is over a full surface area of the main body via the energy source; and
applying a layer to the main body over the full surface area to provide a function layer in respective portions of the main body positioned between the guide blades.
